(19) United States
(12) Patent Application Publication
(10) Pub. No.: US 2026/0064342 A1
(43) Pub. Date: Mar. 5, 2026

(54) DISPLAY CONTROL DEVICE, DISPLAY CONTROL METHOD, AND STORAGE MEDIUM

(71) Applicant: TOYOTA JIDOSHA KABUSHIKI KAISHA, Toyota-shi (JP)

(72) Inventor: Yutaka HAMASAKI, Toyota-shi, (JP)

(73) Assignee: TOYOTA JIDOSHA KABUSHIKI KAISHA, Toyota-shi (JP)

(21) Appl. No.: 19/235,862

(22) Filed: Jun. 12, 2025

(30) Foreign Application Priority Data
Aug. 27, 2024 (JP) 2024-145730

(51) Int. Cl. G06F 3/14

(52) U.S. Cl. CPC G06F 3/14

(57) ABSTRACT

A control device that controls display of an image display unit displaying an image toward an occupant of a vehicle according to a mode of a power switch of the vehicle, the control device being configured to display travel information related to travel of the vehicle in a predetermined area of the image display unit in a case where the mode is a first mode in which the vehicle is in travelable state; and display an image or a video that matches a preference of the occupant of the vehicle in the area in a case where the mode is a second mode in which an image is displayed on the image display unit and the mode is a mode that does not assume travel of the vehicle.

### CROSS-REFERENCE TO RELATED APPLICATION

This application claims priority to Japanese Patent Application No. 2024-145730 filed on Aug. 27, 2024. The disclosure of the above-identified application, including the specification, drawings, and claims, is incorporated by reference herein in its entirety.

### BACKGROUND

### 1. Technical Field

The present disclosure relates to a display control device, a display control method, and a storage medium.

### 2. Description of Related Art

Japanese Unexamined Patent Application Publication No. 2022-151067 (JP 2022-151067 A) discloses that a state image related to a state of a vehicle, such as a vehicle speed, is displayed in a center portion of an image display unit (head-up display). In addition, an awakening device configured to display an awakening image for promoting awakening of a vehicle occupant in a region on a lower side of an outer edge portion of the image display unit, the region not overlapping with the state image, is disclosed.

### SUMMARY

The center portion of the image display unit is basically a region having high visibility that is easily seen by a human eye. Therefore, various pieces of information (hereinafter, referred to as “travel information”) related to travel of a vehicle are usually displayed in the center portion of the image display unit. The center portion is, for example, a display such as a meter display for notifying or providing information to a vehicle occupant, particularly a driver. The travel information is, for example, information needed or useful while the vehicle travels, such as a vehicle speed, a monitoring status of a peripheral environment, and an operation status of a driving assistance function.

On the other hand, such travel information does not always need to be displayed when a mode of the vehicle is a mode that is not based on a premise of travel of the vehicle, such as an accessory (ACC) mode. Therefore, there is a problem that the region of the image display unit having high visibility is not always effectively utilized in the mode in which such travel of the vehicle is not a premise.

The present disclosure has been made in view of the above problems, and an object of the present disclosure is to effectively utilize a region of an image display unit having high visibility.

In order to solve the above problem, a display control device according to an aspect of the present disclosure is configured to
control, according to a mode of a power switch of a vehicle, display of an image display unit displaying an image toward an occupant of the vehicle,
display travel information related to travel of the vehicle in a predetermined area of the image display unit in a case where the mode is a first mode in which the vehicle is able to travel, and display an image or a video that matches a preference of the occupant of the vehicle in the area in a case where the mode is a second mode in which the mode is a mode that is not based on a premise of travel of the vehicle and an image is displayed on the image display unit.

In addition, a display control method according to an aspect of the present disclosure includes:
controlling, according to a mode of a power switch of a vehicle, display of an image display unit displaying an image toward an occupant of the vehicle;
displaying travel information related to travel of the vehicle in a predetermined area of the image display unit in a case where the mode is a first mode in which the vehicle is able to travel; and
displaying an image or a video that matches a preference of the occupant of the vehicle in the area in a case where the mode is a second mode in which the mode is a mode that is not based on a premise of travel of the vehicle and an image is displayed on the image display unit.

In addition, a storage medium according to an aspect of the present disclosure stores a computer program that causes a computer to execute a process. The process includes:
controlling, according to a mode of a power switch of a vehicle, display of an image display unit displaying an image toward an occupant of the vehicle;
displaying travel information related to travel of the vehicle in a predetermined area of the image display unit in a case where the mode is a first mode in which the vehicle is able to travel; and
displaying an image or a video that matches a preference of the occupant of the vehicle in the area in a case where the mode is a second mode in which the mode is a mode that is not based on a premise of travel of the vehicle and an image is displayed on the image display unit.

According to the aspect of the present disclosure, the region of the image display unit having high visibility can be effectively utilized.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a display device according to an embodiment of the present disclosure;

FIG. 2 is a diagram showing one display example of an image display unit when a mode of a power switch is the ON mode;

FIG. 3 is a diagram showing one display example of the image display unit when the mode of the power switch is the ACC mode;

FIG. 4 is a diagram showing an example of an upper position of the image display unit; and

FIG. 5 is a flowchart for describing details of display control according to the embodiment of the present disclosure.

### DETAILED DESCRIPTION OF EMBODIMENTS

Hereinafter, embodiments of the present disclosure will be described in detail with reference to the drawings. In the following description, the same reference numerals are given to the same constituent elements.

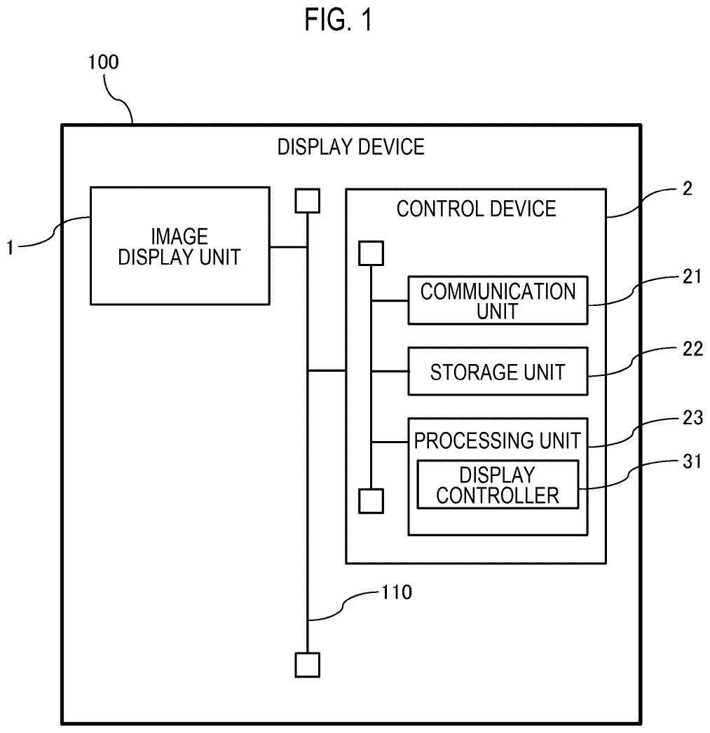

FIG. 1 is a schematic configuration diagram of a display device 100 according to an embodiment of the present disclosure.

The display device 100 includes an image display unit 1 and a control device 2. The image display unit 1 and the control device 2 are communicably connected to each other via an internal network 110 conforming to a standard, such as a controller area network.

The image display unit 1 is an output device that notifies or provides information to the vehicle occupant through vision, and is, for example, a display such as a meter display, a center display, or a head-up display. The image display unit 1 displays information in response to a display signal received from the control device 2. The image display unit 1 according to the present embodiment is a meter display that provides various notifications or various pieces of information to the driver.

The control device 2 is an electronic control unit (ECU) including a communication unit 21, a storage unit 22, and a processing unit 23.

The communication unit 21 includes an interface circuit for connecting the control device 2 to the internal network 110. The communication unit 21 outputs various display signals output from the processing unit 23 to the image display unit 1.

The storage unit 22 has a storage medium, such as a hard disk drive (HDD), a solid disk drive (SSD), or a semiconductor memory, and stores various computer programs, data, and the like used for processing in the processing unit 23.

The processing unit 23 has one or a plurality of central processing units (CPUs) and peripheral circuits thereof, and executes various computer programs stored in the storage unit 22. The processing unit 23 is, for example, a processor. The processing unit 23 functions as a display controller 31 and operates as a functional unit (module) that realizes a predetermined function by executing processing in accordance with a computer program. In the following description, when describing the processing with the display controller 31 as a subject, it is indicated that the processing unit 23 executes a program for realizing the display controller 31.

The display controller 31 controls a display content of the image display unit 1 to the display content according to the mode of the power switch of the vehicle. In the present embodiment, there are three types of modes of the power switch of the vehicle, that is, an OFF mode, an accessory (ACC) mode, and an ON mode. The OFF mode is a mode in which the function of the vehicle is stopped to put the vehicle into a stop state. The ACC mode is a mode that does not assume travel of the vehicle, and is a mode in which the power is supplied to some electrical components including the image display unit 1, but the vehicle cannot travel. The ON mode is a mode in which power is supplied to all the electrical components to enable the vehicle to travel.

When the mode of the power switch of the vehicle is the OFF mode, the display controller 31 sets the image display unit 1 to a non-display state in which power is not supplied.

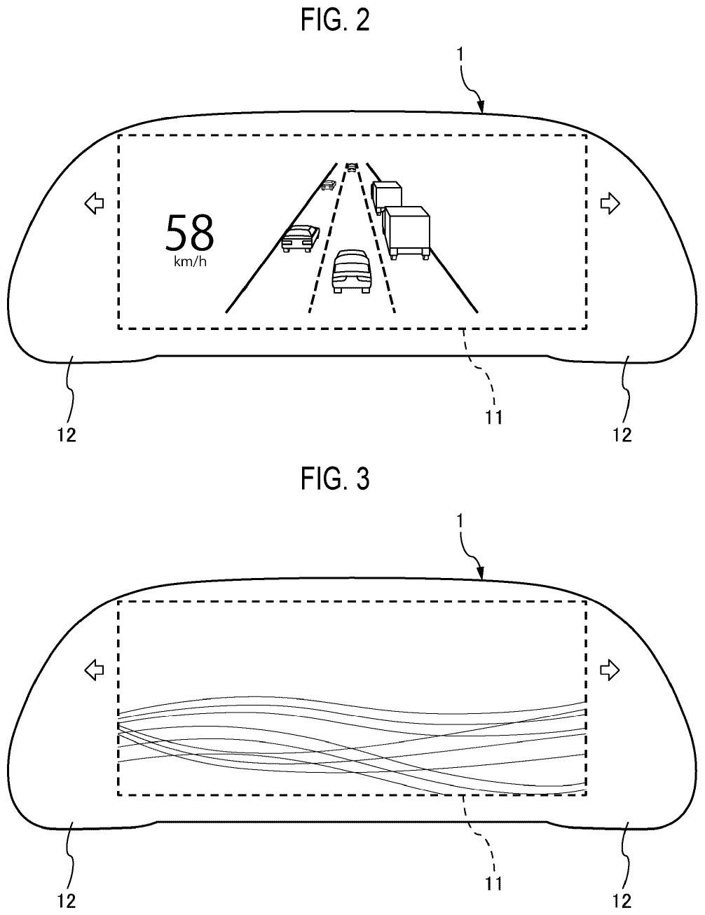

When the mode of the power switch of the vehicle is the ON mode, that is, when the power is supplied to all the electrical components to enable the vehicle to travel, as shown in FIG. 2, the display controller 31 displays the travel information on the center portion 11 of the image display unit 1, which is a region having high visibility that is easily seen by the driver. The display controller 31 displays a display light, such as a turn signal display light or a tail light display light, and a warning light, such as a brake warning light or a charging warning light, on the outer edge portion 12 around the center portion of the image display unit 1 as needed. The travel information is, that is, various pieces of information needed or useful while the vehicle travels, which are related to the travel of the vehicle, such as the vehicle speed, the monitoring status of the peripheral environment, and the operation status of the driving assistance function. In addition, in FIG. 2, solely the turn signal display light is shown in the outer edge portion 12. Further, FIG. 2 is a diagram for facilitating the understanding of the disclosure, and it should be understood that all the displays displayed on the center portion 11 are not displayed in FIG. 2.

Here, when the mode of the power switch of the vehicle is the ACC mode, the power is supplied to some electrical components including the meter display as the image display unit 1, but the vehicle is in a stopped state in which the vehicle cannot travel. Therefore, it is not always needed to display the travel information on the image display unit 1.

Therefore, as shown in FIG. 3, in the present embodiment, when the mode of the power switch of the vehicle is the ACC mode, a predetermined image different from the image related to the travel information is displayed on the center portion 11 of the image display unit 1, which is a region having high visibility that is easily seen by the driver. The center portion 11 is, that is, a region that displays the travel information. The predetermined image can be an image or a video that matches a preference of the vehicle occupant, and in the present embodiment, the image or the video selected by the vehicle occupant from among a plurality of images or videos for a screen background prepared in advance is displayed as the predetermined image. FIG. 3 shows an image (so-called wallpaper) for the screen background selected by the vehicle occupant, but the present disclosure is not limited to such an example, and any image or video prepared by the vehicle occupant may be displayed.

As a result, when the mode of the power switch of the vehicle is the ACC mode, that is, when the vehicle is in the stopped state, the image or the video that matches the preference of the driver can be displayed on the center portion 11 of the meter display (image display unit 1) which is the region having high visibility to the driver. Therefore, the commodity value can be increased. In addition, the display light and the warning light displayed on the outer edge portion 12 of the meter display (image display unit 1) and the image or the video displayed on the center portion 11 do not overlap. Therefore, the display light and the warning light are restrained from being difficult to see due to the background color of the image or the video displayed on the center portion 11. In other words, the display light and the warning light displayed on the outer edge portion 12 of the meter display (image display unit 1) and the image or the video displayed on the center portion 11 do not overlap. Therefore, an image or a video that is free from restrictions, such as a background color, can be displayed on the center portion 11 in accordance with the preference of the driver.

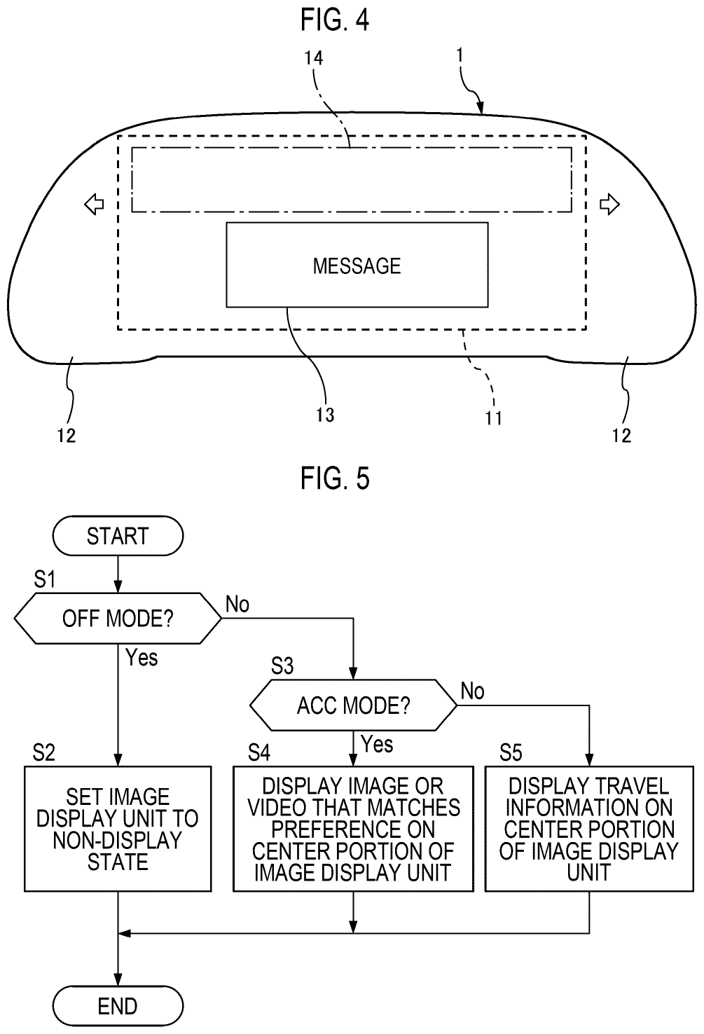

As shown in FIG. 4, a part of the center portion 11 of the meter display as the image display unit 1 (in the example of FIG. 4, a region of a part of the lower side of the center portion 11) may be used to temporarily pop up and display various messages to the driver as needed to the message display unit 13. Various messages are a proposal message, a warning message, and the like. In this case, for example, an image or a video that matches the preference of the driver may be displayed on the upper portion 14 of the meter display that does not overlap the message display unit 13 (the upper region of the center portion 11 in the example of FIG. 4).

FIG. 5 is a flowchart for describing details of the display control according to the present embodiment. The control device 2 repeatedly executes the present routine at a predetermined calculation cycle.

In S1, the control device 2 determines whether the mode of the power switch of the vehicle is the OFF mode. When the mode of the power switch of the vehicle is the OFF mode, the control device 2 proceeds to the process of S2. On the other hand, when the mode of the power switch of the vehicle is not the OFF mode, the control device 2 proceeds to the process of S3.

In S2, the control device 2 sets the image display unit 1 to a non-display state.

In S3, the control device 2 determines whether the mode of the power switch of the vehicle is the ACC mode. When the mode of the power switch of the vehicle is the ACC mode, the control device 2 proceeds to the process of S4. On the other hand, when the mode of the power switch of the vehicle is not the ACC mode, that is, when the mode of the power switch of the vehicle is the ON mode, the control device 2 proceeds to the process of S5.

In S4, the control device 2 displays an image or a video that matches the preference of the driver on the center portion 11 of the image display unit 1, and displays the display light and the warning light on the outer edge portion 12 as needed.

In S5, the control device 2 displays the travel information on the center portion 11 of the image display unit 1, and displays the display light and the warning light on the outer edge portion 12 as needed.

The control device 2 (display control device) according to the embodiment described above is configured to
control display of the image display unit 1 displaying the image toward the occupant of the vehicle according to the mode of the power switch of the vehicle,
display the travel information related to travel of the vehicle in the center portion 11 (predetermined area) of the image display unit 1 in a case where the mode of the power switch of the vehicle is the ON mode (first mode) in which the vehicle is in travelable state, and
display the image or the video that matches the preference of the occupant of the vehicle on the center portion 11 of the image display unit 1 in a case where the mode of the power switch of the vehicle is the ACC mode (second mode) in which the image is displayed on the image display unit 1 and the mode is a mode that does not assume travel of the vehicle.

As a result, in a case where the mode of the power switch of the vehicle is the ACC mode, the image or the video that matches the preference of the vehicle occupant can be displayed on the center portion 11 of the image display unit 1, which is a region having high visibility that is easily seen by the vehicle occupant. When the mode is the ACC mode, it means, that is, when the vehicle is in the vehicle stopped state without assuming travel of the vehicle. Therefore, when the vehicle is in the vehicle stopped state without assuming travel of the vehicle, the commodity value can be increased by effectively utilizing the region of the image display unit 1 with high visibility.

Although the embodiments of the disclosure have been described above, the above embodiments merely show a part of application examples of the disclosure, and are not intended to limit the technical scope of the disclosure to the specific configurations of the embodiments.

For example, the control device 2 (display control device) according to the modification example of the present embodiment is configured to display an image or a video that matches the preference of the occupant of the vehicle in a part of the center portion 11 (predetermined area) when the mode of the power switch of the vehicle is the ACC mode (second mode). A part of the center portion 11 (predetermined area) is an upper portion of the image display unit 1 in the vehicle up-down direction. As a result, when the vehicle is in the vehicle stopped state without assuming travel of the vehicle, the region of the upper portion 14 of the image display unit 1 having high visibility of the image display unit 1 can be effectively utilized to enhance the commodity value. Further, other needed information, for example various messages, such as a proposal message or a warning message to the vehicle occupant, can be displayed at the lower center of the image display unit 1, so that the vehicle occupant can pay attention to the needed information.

In the above-described embodiment, the computer program executed by the control device 2 may be provided in a form recorded on a computer-readable portable recording medium (storage medium), such as a semiconductor memory, a magnetic recording medium, or an optical recording medium.

What is claimed is:

1. A display control device configured to control, according to a mode of a power switch of a vehicle, display of an image display unit displaying an image toward an occupant of the vehicle, the display control device being configured to
display travel information related to travel of the vehicle in a predetermined area of the image display unit in a case where the mode is a first mode in which the vehicle is able to travel, and
display an image or a video that matches a preference of the occupant of the vehicle in the area in a case where the mode is a second mode in which the mode is a mode that is not based on a premise of travel of the vehicle and an image is displayed on the image display unit.

2. The display control device according to claim 1, wherein the area is a center portion of the image display unit.

3. The display control device according to claim 1, wherein:
in a case where the mode is the second mode, the image or the video that matches the preference of the occupant of the vehicle is displayed in a part of the area; and
the part of the area is an upper part of the image display unit in a vehicle up-down direction.

4. A display control method of controlling, according to a mode of a power switch of a vehicle, display of an image display unit displaying an image toward an occupant of the vehicle, the display control method comprising:
displaying travel information related to travel of the vehicle in a predetermined area of the image display unit in a case where the mode is a first mode in which the vehicle is able to travel; and
displaying an image or a video that matches a preference of the occupant of the vehicle in the area in a case where the mode is a second mode in which the mode is a mode that is not based on a premise of travel of the vehicle and an image is displayed on the image display unit.

5. A non-transitory storage medium storing a computer program causing a computer to execute a process, the process comprising:
controlling, according to a mode of a power switch of a vehicle, display of an image display unit displaying an image toward an occupant of the vehicle;
displaying travel information related to travel of the vehicle in a predetermined area of the image display unit in a case where the mode is a first mode in which the vehicle is able to travel; and
displaying an image or a video that matches a preference of the occupant of the vehicle in the area in a case where the mode is a second mode in which the mode is a mode that is not based on a premise of travel of the vehicle and an image is displayed on the image display unit.
